(19) United States
(12) Patent Application Publication
(10) Pub. No.: US 2003/0151604 A1
(43) Pub. Date: Aug. 14, 2003

(54) Volume rendering with contouring texture hulls

(75) Inventors: Arie E. Kaufman, Plainview, NY (US); Wei Li, Stony Brook, NY (US)

Correspondence Address: F. CHAU & ASSOCIATES, LLP, Suite 501, 1900 Hempstead Turnpike, East Meadow, NY, 11554, US

(73) Assignee: RESEARCH FOUNDATION OF STATE UNIVERSITY OF NEW YORK

(21) Appl. No.: 10/301,399

(22) Filed: Nov. 21, 2002

Related U.S. Application Data
(60) Provisional application No. 60/331,775, filed on Nov. 21, 2001.
(60) Provisional application No. 60/421,412, filed on Oct. 25, 2002.

(51) Int. Cl. G06T 15/00

(52) U.S. Cl. 345/419

(57) ABSTRACT

A system and method for texture-based volume rendering accelerated by contouring texture hulls is provided. Bounding geometries, such as rectangles, cuboids, or the like surrounding the non-empty regions as well as the contouring borders of the non-empty regions are found. The bounding shapes are treated as the hulls of the non-empty sub-textures. The nonempty sub-textures are stored and rendered. Texels outside the hulls are skipped.

### CONTINUATION DATA

This application claims priority to provisional applications, serial No. 60/331,775, filed Nov. 21, 2001, and serial No. 60/421,412, filed Oct. 25, 2002, the disclosures of which are incorporated by reference herein.

### TECHNICAL FIELD

The present invention relates to volume rendering; specifically, volume rendering using bounding geometries and contouring texture hulls.

### DISCUSSION OF RELATED ART

General-purpose texture-mapping hardware has been used in direct volume rendering for a number of years. With recent advances in graphics hardware, the rendering speed has dramatically increased. Other features that improve image quality, such as lighting and trilinear interpolation, have improved as well.

The principle of texture-based volume rendering is to represent a volume as a stack of slices, either image-aligned or volume-aligned. The slices are then treated as two dimensional (2D) texture images and mapped to a series of polygons in three dimensional (3D) space, hence the texels are composited with pixel-oriented operations available in graphics hardware. For example, to render the lobster data set shown in FIG. 1a, a stack of slices are extracted from the volume. FIG. 1b shows one such slice. In general texture-based volume rendering, each slice is loaded in full and all the texels falling into the view frustum are rendered.

Typically, a volumetric data set has a significant amount of voxels with zero values, meaning empty data with no contribution to the image being rendered. In addition, for many studies, some parts of the volume are removed to reveal other parts which are of no interest to the observer, hence are assigned a fully transparent (invisible) opacity, or as empty voxels. As can be seen in FIG. 1b, many of the regions on the slice are completely empty.

Texture-based volume rendering using general-purpose graphics hardware generates images with quality comparable to software-based methods and at much higher speed than software-only approaches. By storing gradient in a separate volume, texture-based volume rendering can also achieve limited lighting effects. Recently, extensions of the graphics hardware, such as multi-texture, register combiners, paletted texture, and dependent texture, have been explored to implement trilinear-interpolation on 2D texture hardware, performance enhancement, diffuse and specular lighting, and pre-integrated volume rendering. See Engel, K., Kraus, M., and Ertl, T., 2001, High-Quality Pre-integrated Volume Rendering Using hardware-Accelerated Pixel Shading, Eurographics/SIGGRAPH Workshop on Graphics Hardware, and Rezk-Salama, C., Engel, K., Bauer, M., Greiner, G., and Ertl, T., 2000, Interactive volume rendering on standard PC graphics hardware using multi-textures and multi-stage rasterization, SIGGRAPH/Eurographics Workshop on Graphics Hardware (August), p.109-118.

There have been efforts made in applying empty space skipping in texture-based volume rendering. In Boada, I., Navazo, I., and Scopigno, R. 2001, Multiresolution Volume Visualization with a Texture-Based Octree, The Visual Computer 17, 3, 185-197 and LaMar, E., Hamann, B., and Joy, K. I., 1999, Multiresolution techniques for interactive texture-based volume visualization. IEEE Visualization (October), 355-362, the texture space is segmented into an octree. They skip nodes of empty regions and use lower-resolution texture for regions far from the viewpoint or of lower interest. In Westermann, R., Sommer, O., and Ertl, T. 1999, Decoupling polygon rendering from geometry using rasterization hardware, Eurographics Rendering Workshop (June), 45-56, bounding boxes are exploited to accelerate voxelized polygonal surfaces stored as 3D textures. The size of the bounding boxes is controlled by the number of primitives enclosed, hence the adjacent primitives sharing vertices may be separated to different bounding boxes and resterized into different textures. Both the octree nodes and the bounding boxes may partition continuous non-empty regions, hence neighboring textures should store duplicated texels at texture borders for proper interpolation.

Software processing such as ‘space leaping’ have been employed to accelerate volume rendering. Space leaping avoids processing empty voxels along rays, with the help of various pre-computed data structures, such as pyramid of binary volumes in Levoy, M., 1990. Efficient ray tracing of volume data. ACM Transactions on Graphics 9, 3 (July), 245-261 proximity cloud in Cohen, D., and Sheffer, Z., 1994. Proximity clouds, an acceleration technique for 3D grid traversal. The Visual Computer 11, 1, 27-28, macro regions in Devillers, O., 1989. The macro-regions: an efficient space subdivision structure for ray tracing. Eurographics (September), 27-38 and bounding convex polyhedrons in Li, W., Kaufman, A., and Kreeger, K. 2001. Real-time volume rendering for virtual colonoscopy. In Proceedings Volume Graphics, 363-374. Similar data structures, such as bounding cell Li, W., Kaufman, A., and Kreeger, K., 2001; Wan, M., Bryson, S. and Kaufman, A., 1998, 3D adjacency data structure Orchard, J., and Moller, T., 2001, and run-length encoding Lacroute, P., and Levoy, M., 1994. Fast volume rendering using a shear-warp factorization of the viewing transformation. Proceedings of SIGGRAPH (July), 451-458, have been utilized to directly skip the empty voxels in object-order method, usually referred to as empty space skipping.

In Knittel, G. 1999. TriangleCaster: extensions to 3D-texturing units for accelerated volume rendering. SIGGRAPH/Eurographics Workshop on Graphics Hardware (August), 25-34, proposed TriangleCaster, Knittel G., 1999, a hardware extension for 3D texture-based volume rendering. Knittel also exploited the bounding hull scan conversion algorithm for space leaping. Westermann, R., and Sevenich, B., 2001 developed a hybrid algorithm that employs texture hardware to accelerate ray casting. Both of the methods are similar to PARC Avila, R., Sobierajski, L., and Kaufman, A., 1992 in that the positions of the nearest (and the farthest) non-empty voxels are obtained from the depth buffer. These approaches have not proven to be efficient in processing of empty, interleaved empty and non-empty regions.

Texture-based volume rendering can also take advantage of the multi-texture extension of OpenGL. (See, OpenGL Programming Guide, by OpenGL Architecture Review Board—Jackie Neider, Tom Davis, and Mason Woo, an Addison-Wesley Publishing Company, 1993, which is hereby incorporated by reference). By associating each pixel with multiple texels and utilizing the multi-stage rasterization, various enhancement, such as trilinear interpolation, performance enhancement (See, Rezk-Salama, C., Engel, K., Bauer, M. Greiner, G., and Ertl, T., 2000. Interactive volume rendering on standard PC graphics hardware using multi-textures and multi-stage rasterization. SIGGRAPH/Eurographics Workshop on Graphics Hardware (August), 109-118), and pre-integrated volume rendering (See, Engel, K., Kraus, M., and Ertl, T., 2001. High-Quality Pre-Integrated Volume Rendering Using hardware-Accelerated Pixel Shading. In Eurographics/SIGGRAPH Workshop on Graphics Hardware, 9.) are obtained. With multi-texture extension, trilinear interpolation can be achieved in 2D texture-based volume rendering (See, Rezk-Salama, C., Engel, K., Bauer, M. Greiner, G., and Ertl, T., 2000. Interactive volume rendering on standard PC graphics hardware using multi-textures and multi-stage rasterization. SIGGRAPH/Eurographics Workshop on Graphics Hardware (August), 109-118), which used to be its main disadvantage against the approaches based on 3D textures. For better understanding of the present invention, the above cited references are incorporated by reference herein.

A need therefore exists for a system and method for efficiently rendering 3D images by finding contouring borders of non-empty regions and discarding regions external thereof.

### SUMMARY OF THE INVENTION

Accordingly to an aspect of the present invention, a method is provided for rendering a three dimensional (3D) image, comprising slicing the 3D image into a plurality of two dimensional (2D) slices; generating one or more 2D bounding geometries for each of the 2D slices, each bounding geometry having nonempty texels representing portions of the 3D image; and rendering the 3D image by processing texels within each said bounding geometry. Preferably, the bounding geometry is a rectangle. The rendering step includes generating a loop formed from contouring edges approximating boundaries of each connected regions of nonempty texels representing portions of the image within each said bounding geometry; and rendering the 3D image by processing texels within each said loop.

According to another aspect of the invention, the step of generating one or more bounding geometries includes grouping adjacent slices into a compressed slice, wherein compressed slice is by use of a logical OR operation.

The method further includes a step of transforming the compressed slice into a lower resolution form, wherein said step of transforming includes merging each k×k square region into a single voxel, where k is a natural number. The merging can be by low pass filtering. The bounding geometry includes a bitmap mask that describes pixel-wise the nonempty texels enclosed therein.

Further, the step of generating a loop includes identifying an edge between each adjacent empty and nonempty voxel pairs within each bounding geometry; adding each said edge to an edge list connecting edges in the edge list according to direction and contour of the boundary of connected nonempty voxels until the loop is formed. Preferably, the nonempty voxel pairs is defined as 4-neighbor connected and said empty voxel pairs is defined as 8-neighbor connected.

A method according to another embodiment of the invention further includes a simplication step by merging empty voxels into a non-empty voxel region before rendering, and space skipping processing to remove empty voxel regions within the loop prior to rendering.

According to another aspect of the invention, a method is provided for rendering a three dimensional (3D) image, comprising generating one or more 3D bounding geometries for the 3D image, each bounding geometry having nonempty texels representing portions of the 3D image; rendering the 3D image by processing texels within each said bounding geometry, wherein the rendering step Includes generating a loop formed from polygonal surfaces approximating boundaries of each connected regions of nonempty texels representing portions of the image within each said cuboid; and rendering the 3D image by processing texels within each said loop. Preferably, the bounding geometry is a cuboid.

A system is also provided for rendering a three dimensional (3D) image, comprising a bounding rectangle generator for generating one or more bounding geometries, each bounding geometry for bounding regions having nonempty texels representing portions of the 3D image; a loop generator for generating a loop formed from contouring edges approximating boundaries of each connected regions of nonempty texels representing portions of the image within each said bounding geometry; and a rendering processor for rendering the 3D image by processing texels within each said bounding geometry. The system can further include a loop generator for generating a loop formed from contouring edges approximating boundaries of each connected regions of nonempty texels representing portions of the image within each said bounding geometry, wherein said bounding geometries includes one of rectangles and cuboids.

According to still another embodiment of the invention, a program storage device for storing codes executable by a computer to perform a method of rendering a three dimensional (3D) image is provided, the method comprising generating one or more bounding geometries, each for bounding regions having nonempty texels representing portions of the 3D image; and rendering the 3D image by processing texels within each said bounding geometry.

### BRIEF DESCRIPTION OF THE DRAWINGS

FIG. 1a to FIG. 1f shows a volume rendering process according to a preferred embodiment of the present invention.

FIG. 2 illustrates slab overlap processing according to an embodiment of the present invention.

FIG. 3 illustrates a preferred process of boundary tracking.

FIG. 4a and FIG. 4b shows preferred simplification processes according to embodiments of the present invention.

FIG. 5 shows a self-intersection removal process according to an embodiment of the present invention.

FIG. 6 shows a preferred process after a simplification process according to the present invention.

FIGS. 7a to 7f shows transfer functions interaction images.

FIGS. 8a to 8d shows exemplary images generated by a system according to a preferred embodiment of the present invention.

FIGS. 9a and 9b shows exemplary images generated with different transfer functions.

### DETAILED DESCRIPTION OF PREFERRED EMBODIMENTS

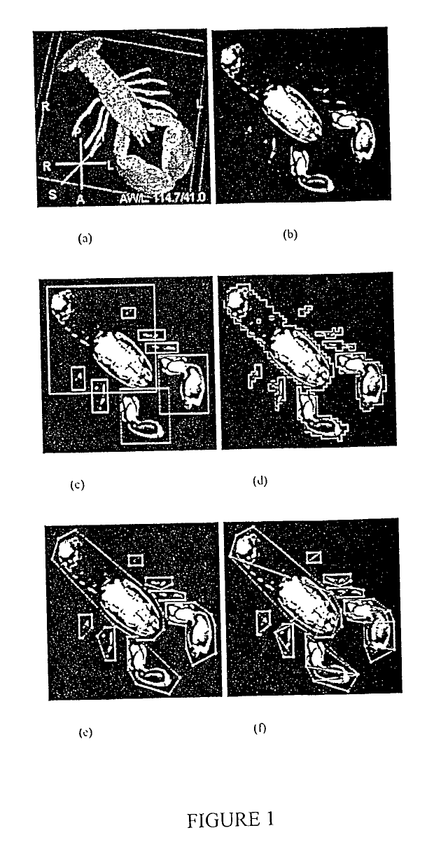

According to preferred embodiments of the invention, bounding geometries such as rectangles and contours are used to approximate the boundaries of the non-empty connected regions on each 2D slice. These bounding geometries or shapes are referred to as texture hulls. Rather than fully rendering every slice, the bounding geometries of each non-empty region are found. For purposes of illustrating preferred embodiments of the present invention, rectangles and contours are used as the bounding geometries. In view of the disclosure of the present invention, one skilled in the art can readily appreciate that bounding geometries of other shapes, such as squares, cuboids, polygons, triangles or the like are applicable to the invention. The sub-images specified by these rectangles shown in FIG. 1c are loaded and rendered. As a result, the requirement of texture memory and the number of voxels composited are significantly reduced. According to a further aspect of the invention, contours are used to describe the non-empty regions, and triangle meshes are used to cover the regions for texture-mapping, shown as meshes in FIG. 1d, to exclude even more empty voxels. Then, the contour is simplified to accelerate the triangulation and reduce the complexity of the meshes, shown in FIG. 1e. The position inside the regions bounded by the contours are then rendered, (FIG. 1f).

For the lobster data set shown in FIGS. 1a to 1f, rendering assisted by the bounding contours gains a speedup factor of 3, from 7 Hz to 22 Hz, on an Nvidia Quadra2 MXR graphics board with exactly the same image quality. Data sets with different transfer functions and the acceleration ratios are found to be in the range of 2 to 12.

The texture hulls are transfer-function-dependent. For applications with fixed transfer function, they can be computed in a pre-processing stage. In cases where the transfer function is dynamically changing, the texture hulls are not recomputed as often as the changes of the transfer function, as discussed below, the bounding information can be generated on the fly.

It is further understood that the present invention may be implemented in various forms of hardware, software, firmware, special purpose processors, or a combination thereof. Preferably, the present invention is implemented in software as a program tangibly embodied on a program storage device. The program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code.

The various processes and functions described herein may either be part of the microinstruction code or part of the program (or combination thereof) which is executed via the operating system. In addition, various other peripheral devices may be connected to the computer platform such as an additional data storage device and a printing device.

It is to be understood that, because some of the constituent system components and method steps depicted in the accompanying figures are preferably implemented in software, the actual connections between the system components (or the process steps) may differ depending upon the manner in which the present invention is programmed.

Preferred graphics hardware and/or computing devices include a Nvidia Quadra2 MXR with 32 MB of memory, a 64 MB Nvidia GeForce 3, or the like. Each graphics hardware is installed in a computer with the capability of a 1 GHz Pentium III processor and 1 GB of RDRAM.

According to an aspect of the present invention, when texture hulls are being rendered, only one stack of textures need to reside in texture memory at a time. Only after the viewing angle has changed significantly will there be a need to switch texture stacks. The delay caused by the switching is tolerable for small to moderate sized data sets on current AGP 4X bus and RDRAM with a typical value of 1 second. To accelerate the rendering, using three stacks of axis-aligned textures can be used as a trade-off between storage and speed. According to a further aspect of the invention, axis-aligned slices are applied to simplify the computation of the texture hulls for 2D texture-based volume rendering.

The bounding rectangles should be as tight as possible and only the sub-slices bounded by them are extracted as textures. Referring again to FIG. 1c which shows the application of bounding rectangles on the corresponding slice, three rectangles enclosing non-empty voxels are formed. The rectangles are overlapping and nested.

Adjacent slices are grouped into slabs and all the slices within a slab are merged into a single compressed slice, preferably with logical “OR” operation. Region growing on the compressed slices are then applied. According to a preferred embodiment of the invention, the compressed slices are transformed into a low-resolution form by merging every k×k square into a single pixel (voxel), thereby exploiting spacial coherence of empty voxels in all the three major directions. In this embodiment, k=4 and d, the thickness in number of slices of the slab is 16. Larger k or larger slab thickness d requires less time for region growing but generates less tight bounding rectangles, which appear with the border of the non-empty regions not being tangent to the boxes. After a set of bounding rectangles is found for each slab, blocks specified by the rectangles are cut from the slab and sub-slices are extracted as textures.

As can be seen in FIG. 1c, although connected-regions are separated by empty voxels, their bounding rectangles may overlap. To prevent duplication of voxel rendering, each rectangle having an enclosed non-empty region is associated with a bitmap mask. When a bit in the mask is non-empty, the voxel is copied into the texture. Otherwise, the texel is set to zero, even if the corresponding voxel is not empty. For nesting bounding rectangles, since the texture image contains all the texels needed by the enclosed sub-slices, the sub-slice shares the texture image of the outermost rectangle while having its own bounding rectangle with a mask.

According to a preferred embodiment of the invention, trilinear interpolation is applied to required slices of neighboring slabs. When creating the compressed slices, each adjacent slab pairs have an overlap of m slices, where m is the number of textures that are mapped to the same polygon. Here, d>=m.

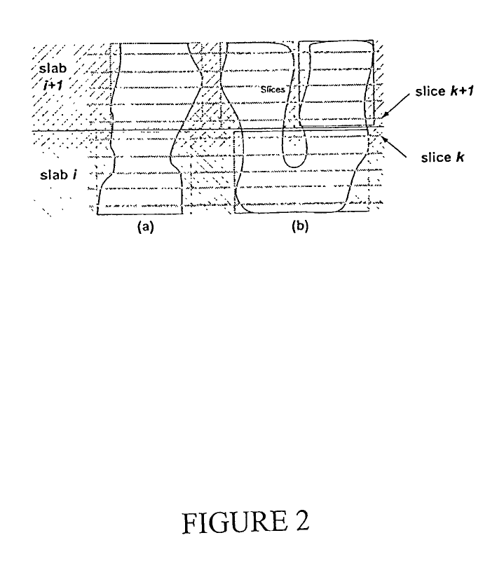

FIG. 2 illustrates the case of m=2 and d=5 with two slabs. The five slices are merged with the one slice from the neighbor for region growing. Therefore, the union of the bounding rectangles of slab i encloses all the non-empty regions on slice k−l, and slab i+1 on slice k. Consequently, the intersections of the rectangles on slice k with the rectangles on slice k−1 covers all the non-empty regions on the two slices. Thus, for slice k, textures of the bounding rectangles of slab i are extracted, for slice k+1, textures from slab i+1 are extracted and so on.

During rendering, of both slice k and slice k+1, the intersection of the rectangle union on the two slices is computed. Since they are axis-aligned, the results are still rectangles. If no rectangle overlaps with others of the same slab, as in the case shown in FIG. 2, every non-empty voxel is enclosed by only one rectangle produced from the intersection, hence every non-empty voxel is rendered only once.

Although bounding rectangles eliminate many empty voxels, significant amount of empty voxels remain if the boundaries of the non-empty regions are winding or not axis-aligned. Moreover, rectangular bounding can include sizable empty regions enclosed within non-empty regions. To eliminate these empty regions, nested contouring is used to better conform the boundaries of a connected non-empty region. Each nested contour model is comprised of a single external contour and zero to multiple internal contours. All contours form closed loops. The nested contour model is then triangulated and the triangular mesh textured with the sub-slices, bordered by the bounding rectangles, are rendered.

The bounding contours contain more polygons than the rectangles, which may increase the burden of the transformation stage. However, since the number of fragments is reduced by the boundary contours, rasterization and texture-based volume rendering is fill bound, and the rendering performance is significantly improved. The detection of the contours is applied on the merged slices containing merged voxels. Preferably, a low-pass filter is used to merge the slices. The filtering and the contour simplification prevent the contours from outlining two small holes. A contouring texture hull process according to an embodiment of the present invention is further described below.

For detecting contours, areas inside the bounding rectangles on the compressed slices are searched. All adjacent empty and non-empty voxel pairs are found. For each pair, the edge separating them is added to an edge list. An edge is preferably either horizontal or vertical. The edges are then connected into closed contours. An examplary pseudo-code for finding the contours follows:

1. while the edge list is not empty do

2. remove an edge from the list

3. create contour, add the end points of the edge to the contour

4. pick one end point as the head and the other as the tail

5. finished □ false

6. while !finished do

7. find the next edge connecting the tail of the partial contour and remove the edge from the list

8. add the new end point to the contour and set it as the new tail

9. accumulate the sweeping angle of the contour

10. if head==tail then

11. finished=true

12. determine the type of the contour by the sweeping angle and the edge type

13. end if

14. end while

15. end while

Each edge added to a contour is treated as a directed edge with the direction pointing from the head to the tail along the contour, hence the edge is classified as either left-empty-right-solid or right-empty-left-solid according to the position of the empty voxel relative to the edge, forming a sweeping angle. All the edges of a contour are the same type. From the sign of the sweeping angle, whether the contour rotates clockwise or counter-clockwise is determined. When the direction of rotation is combined with the edge type, whether the contour is internal or external is determined.

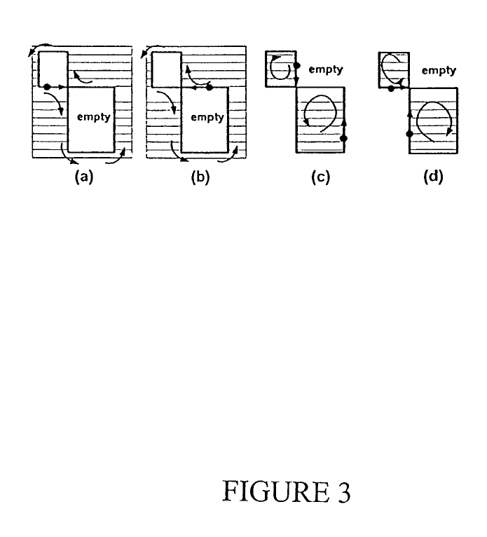

To resolve any ambiguity, an empty region is defined as 8-neighbor connected (e.g., in x, y, and z direction) and a non-empty region as 4-connected (e.g., in x and y direction). Only axis-aligned edges are inserted into the edge list. The edge type helps to choose the next edge if there are multiple candidates. The edge on the non-empty side, if there is any, of the current edge is chosen as the next edge. An example is illustrated in FIG. 3. FIGS. 3a and 3b show the generation of a single internal contour. The dot denotes the starting point and arrow preceding the dot shows direction. The curved arrows describes the shape and direction of the contours. The produced contours are independent of the starting point or the starting direction, except that the direction of the contour may be reversed. Two external contours are generated in FIGS. 3c and 3d.

According to a further aspect of the present invention, upon detection of the boundary contours, the texture hulls are further simplified. Known simplification approaches such as triangulation of the contours obtained by edge tracking or generation of a sequence of nested approximating meshes produce more complicated meshing and thus much time is consumed.

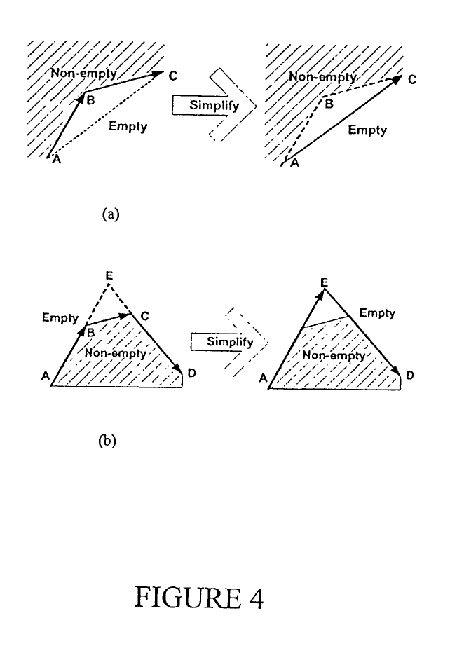

According to one embodiment of the present invention, simplification is by merging empty voxels into a non-empty region. Since the rendering time is approximately linear with the number of voxels rendered, more area is covered with little cost in time. According to another embodiment, simplification is by vertex removal and vertex merging. This process is illustrated in FIG. 4. FIG. 4a shows a vertex removal process with vertex C on the empty side of edge AB, and triangle ABC encloses an empty region. The area of the triangle ABC is smaller than the area threshold ε, vertex B can be deleted and edge AC replaces AB and BC. Unlike removal simplification, vertex merging inserts new vertices as well as deletes old ones. FIG. 4b shows a vertex merging process. When edge AB meets edge CD at E and E lies on the empty side of edge BC, the area of triangle BCE is tested to see if it is smaller than ε. If so, B and C are deleted and E is inserted.

In both operations shown in FIGS. 4a and 4b, the area of a triangle is computed as well as the position of a vertex of the triangle relative to the opposite edge is determined. The two tests are accomplished by computing the following signed area:

S=x₁y₂+y₂y₃+x₃y₁−y₁x₂−y₂x₃−y₃x₁ (1)

where (xᵢ, yₗ) are the coordinates of vertex Vᵢ. The area of triangle V₁V₂V₃ is 0.5|S|, that is, half of the absolute value of S. The position of V₃ relative to the directed edge is:

on the left S>0

on the right S<0

on the line S=0

Preferably, a simplification process is repeatedly applied until no vertex can be removed or merged. A non-empty region enlarges monotonically, hence ensures the enclosure of the original region. Further, an external contour does not intersect with any internal contour inside it and the internal contours enclosed by the same external contour do not intersect with each other. Performing each operation reduces the number of vertices by 1. If we require a contour to contain at least three points, then at most n−3 operations can be applied to it, where n is the number of vertices on the contour.

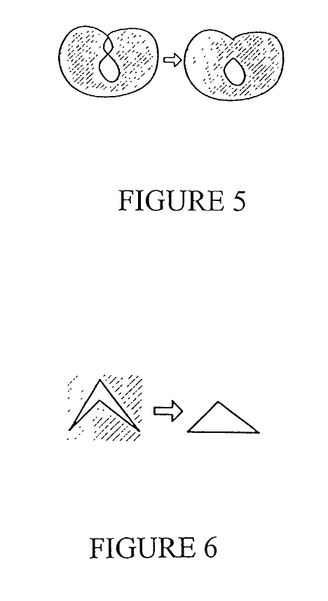

Although the above-described simplification process guarantees no intersection of external and internal contours, it is possible that a contour intersects itself. It happens mostly for external contours with concave shapes, as shown on the left side of FIG. 5.

To remove the self-intersection of a contour, the contour is traversed to find intersection points. The intersection points are classified as one of two types, empty-to-nonempty (EN) and nonempty-to-empty (NE), depending on whether the directed edge is thrusting from empty to non-empty region or vice versa. Next, the contour is divided into curve segments by the intersection points and using the intersection points as their end points.

Only curve segments starting with an NE end point and ending with an EN end point are preserved. Then, by connecting those curve segments, one or more contours is obtained. Further, the sweeping angle of each contour is also evaluated and whether the region enclosed in a contour is empty or non-empty is determined. FIG. 5 shows that the self-intersection of an external contour is removed and the contour is split into two contours, one is external (red) and the other is internal (greenish blue).

Small internal contours may flip after simplification, as shown in FIG. 6. In such case, the type of the edges and the sign of the swept angle when walking along the contour can be used to determine whether the region it encloses is empty or not. If the contour contains a non-empty region, which is impossible by definition, the internal contour is discarded.

It is known that sliver triangles with extremely slim shape degrade the performance of texture mapping. Delaunay triangulation is a known process for triangles of this type. Delaunay avoids small internal angles and equalateralizes the triangles. According to a further aspect of the invention, Delaunay triangulation is applied on the contours. When triangulating the nested contour model, all the edges on the contours are forced to be part of the triangulation. Although there are arbitrary levels of nesting, a single level of nesting is used. In certain contouring wherein there appears to be multi-level nesting, such as when an external contour and its internal contours is completely enclosed in another external contour, only the non-empty region that is between an external contour and its internal contours is of interest. Therefore, an external contour is handled independently on other external contours.

Rendering is performed after contour simplification. Rendering from the volume bounded by texture hulls is by texture mapping the sub-slice images onto either the bounding rectangles or the triangular meshes. The texture coordinates of the vertices are obtained during the computation of the bounding rectangles or the bounding contours, and are stored with the vertice. As previously described for the simplification process, the vertices of the contours may move outside of the corresponding bounding rectangles (see FIGS. 1e and 1f); hence, the texture coordinates can be out of the range of (0, 1).

It can be readily appreciated by one skilled in the art that the above described preferred embodiments of processing, e.g., rectangles and other contouring geometries, can be used separately or in the aggregate, depending on problems posed in individual cases. It can be further appreciated that the use of bounding geometries and rendering processes described above are applicable to 3D images without stacking 2D slices. In such embodiment, 3D boundary geometries, such as cuboids are used in place of rectangles. The contouring loops are also 3D in the form of polygonal surfaces.

In most applications, rendering from a contour-bounded texture volume significantly out-performs that from the same data sets with only bounding geometries. However, for some data set, the bounding geometries such as rectangles excludes sufficient empty space or the structure inside the volume is close to axis-aligned. In such cases, all the processes used for the contours and the triangular meshes may not be needed to produce the same result.

In another example, the bounding contours cause a new problem for using slices from different slabs, because it is impractical to compute the intersection of two triangular meshes on-the-fly. In such case, one may choose to find, at the preprocessing stage, the nested contour model and its triangulation for the m overlapped slices of each adjacent slab pair. Alternatively, only the bounding rectangles are used and the contours for those slices are ignored.

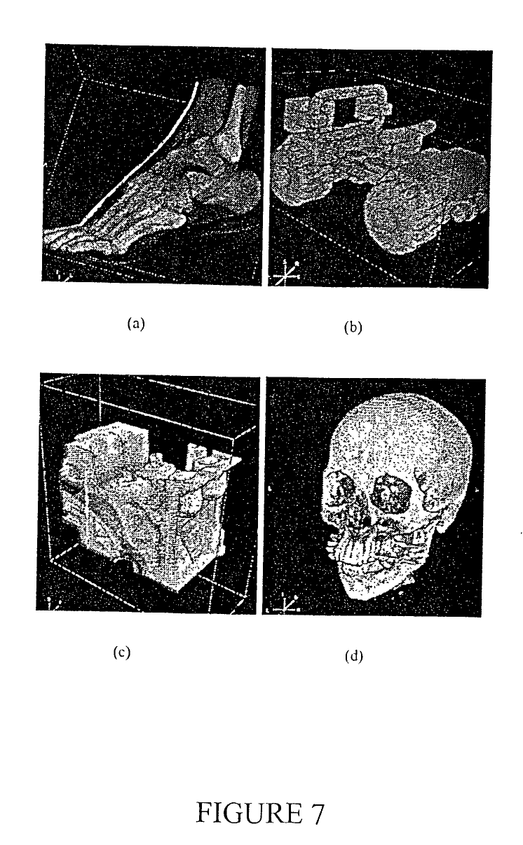

Referring again to the 2D slices, both the bounding rectangles and the bounding contours depend on the transfer function. There are two exemplary scenarios for a transfer function to change. In one case, all voxels mapped to empty by the previous transfer function are still treated as empty by the current mapping. As shown in FIGS. 7a, 7c, and 7e, the bounding information is computed based on the transfer function in 7a, and the transfer function is changed to those in 7c and 7e. The rendering results shown in 7c and 7e are correct since all the visible voxels are available in textures. In the another case, previous empty voxels now need to appear. As shown in FIGS. 7b, 7d and 7f, the bounding geometries are computed from the transfer function of 7f and remain unchanged while the transfer function is changed to those in 7d and 7b. The images reveal the shape of the texture hulls. Note that FIGS. 7e and 7f are exactly the same except that they are rendered at different speeds (e.g., 23.7 Hz and 64.0 Hz respectively on a GeForce 3 board).

A system according to the present invention updates the bounding rectangles and the contours lazily so that the system responses to the change of the transfer function interactively. After the new transfer function has been determined, either the user or the system triggers an update of the texture hulls to accelerate the rendering or to remove the artifacts, which takes a few seconds for small to moderate data sets (see Table 5).

According to preferred embodiments of the present invention wherein empty voxels that do not contribute to the rendering are skipped, the image rendered is exactly the same as that generated without the skipping, but at much higher speed.

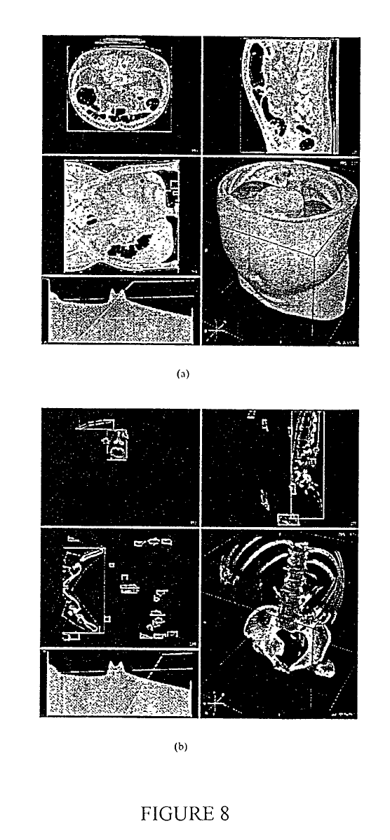

FIGS. 8 and 9 are images produced by texture-based volume rendering with texture hulls and trilinear interpolation processes described above. They are exactly the same as those rendered without the empty space skipping. Valid image area is about 512². All the textures are 2D and are created in color-index format. The texture palette extension is used to support arbitrary transfer functions in the hardware. Because a texture has to be rectangular-shaped, there are usually significant amounts of empty space on the texture images. Preferably, a lossless compression extension for all texture formats can be added to graphics hardware. For example, run-length encoding can be applied to reduce the memory requirements.

FIG. 9 shows the same CT torso data set rendered with different transfer functions as well as three orthogonal slices overlaid with the bounding rectangles and the contours. The rectangles and the contours are dependent on the transfer function. Table 1 lists the size and the source of the volumes rendered in FIGS. 8 and 9, while Tables 2 and 3 give the frame rates as well as the speedup factors of the proposed methods over conventional texture-based volume rendering on two different graphics cards. “Contour FPS” and “Rect. FPS” are the frame rates (im frames per second) of volume rendering accelerated with the bounding contours and the bounding rectangles, respectively. “Basic FPS” is the frame rate with the conventional 2D-texture-based volume rendering. “Contour Speedup” and “Rect. Speedup” are the acceleration ratios of the proposed method over the basic approach. The torso data is too big to render on a board with 32 MB of texture memory, hence no result for the torso data set is reported in Table 3.

As shown, rendering is accomplished at over 20 frames per second for a data set as big as 512×512×361 (torso) for some transfer functions, and a volume of size up to 256³ in real-time or near real-time can be rendered on a high-end commodity graphics hardware. Rendering based on the bounding contours always outperforms rendering based on the bounding rectangles only. With the bounding contours, speed up factors of 2 to 12 are achieved, except for torso 1, which has too few empty voxels.

Table 4 presents the number of voxels rendered for different rendering methods: original (without empty space skipping), rectangle-bounded and contour-bounded, respectively. The values under “Rectangle” and “Contour” are the average of the three stacks, while those for “Original” are independent on the major axis. Since each voxel occupies a byte, the numbers under “Original” and “Rectangle” represent the usage of the texture memory as well. Recall that the contour-bounded textures require the same amount of texture memory as the corresponding rectangle-bounded textures. The numbers in parentheses are the percentage relative to the original approach. Note that the memory saving is no worse than 50% except for torso 1. For the data sets tested, rendering with contour-bounded textures processes 18% to 52% fewer texels than rendering with rectangle-bounded textures, which explains the frame-rate difference in Tables 2 and 3.

TABLE 1
The size and source of the volumetric data sets

| Data set | Size | Source |
|---|---|---|
| torso | 512 × 512 × 361 | patient CT |
| foot | 152 × 256 × 220 | visible male CT |
| toy car | 132 × 204 × 110 | voxelization |
| engine | 256 × 256 × 110 | industrial CT |
| head | 256 × 256 × 225 | patient CT |
| lobster | 256 × 254 × 57 | CT (human scanner) |

TABLE 2
Frame rates on a 64 MB GeForce3 card

| | Contour | | | Contour | Rect. |
|---|---|---|---|---|---|
| Data Set | FPS | Rect. FPS | Basic FPS | Speedup | Speedup |
| torso 1 | 2.85 | 2.84 | 1.80 | 1.58 | 1.58 |
| torso 2 | 22.06 | 17.46 | 1.80 | 12.25 | 9.70 |
| foot | 43.67 | 40.87 | 10.80 | 4.04 | 3.78 |
| toy car | 44.64 | 43.60 | 21.82 | 2.07 | 2.05 |
| engine | 24.93 | 22.07 | 10.85 | 2.30 | 2.03 |
| head | 22.06 | 21.57 | 9.79 | 2.25 | 2.20 |
| lobster | 83.56 | 44.62 | 22.07 | 3.68 | 2.02 |

Table 5 shows the time in seconds for computing the bounding rectangles and the bounding contours. It is the total computation time for the three texture stacks since we are using 2D textures. For data sets up to 256³, there are a few seconds delay for each re-computation of the bounding information which is tolerable for interactive visualization.

TABLE 3
Frame rates on a 32 MB Quadro2MXR card

| | Contour | | | Contour | Rect. |
|---|---|---|---|---|---|
| Data Set | FPS | Rect. FPS | Basic FPS | Speedup | Speedup |
| foot | 29.10 | 21.10 | 3.45 | 8.43 | 6.12 |
| toycar | 12.39 | 9.74 | 5.61 | 2.21 | 1.66 |
| engine | 8.65 | 7.87 | 3.8 | 2.28 | 2.07 |
| head | 6.27 | 5.47 | 2.31 | 2.71 | 2.37 |
| lobster | 22.06 | 14.65 | 6.98 | 3.16 | 2.10 |

TABLE 4
Voxels rendered (in million)

| Data Set | Original | Rectangle | Contour |
|---|---|---|---|
| torso 1 | 46.7 | 36.9 (79%) | 30.3 (65%) |
| torso 2 | 46.7 | 7.7 (17%) | 3.7 (8%) |
| foot | 8.6 | 1.4 (17%) | 0.8 (9%) |
| toy car | 3.0 | 1.5 (50%) | 1.1 (37%) |
| engine | 7.2 | 3.0 (42%) | 2.1 (29%) |
| head | 14.7 | 6.1 (41%) | 4.6 (31%) |
| lobster | 3.7 | 1.0 (26%) | 0.6 (16%) |

TABLE 5
Total time (in sec) for computing the bounding information
for all the three stacks of textures

| Data Set | Rectangle | Contour | Total |
|---|---|---|---|
| torso 1 | 69.63 | 7.08 | 76.71 |
| torso 2 | 65.96 | 1.19 | 67.15 |
| foot | 7.44 | 0.27 | 7.71 |
| toy car | 1.53 | 0.16 | 1.69 |
| engine | 4.89 | 0.27 | 5.16 |
| head | 13.15 | 1.14 | 14.29 |
| lobster | 2.55 | 0.25 | 2.80 |

While the foregoing has given a basic description of image generation and accelerating volume rendering with texture hulls, it should be appreciated that features or techniques known or available to one ordinary skilled in the art are only briefly described, for purposes of illustrating embodiments of the invention herein. For example, a graphics accelerator of one or more preferred embodiments is designed for operation in systems that employ OpenGL, which is a well known graphics application program interface (API).

The foregoing description has been presented for purposes of illustration and description. Obvious modifications or variations are possible in light of the above teachings. All such modifications and variations are within the scope of the invention as determined by the appended claims.

We claim:

1. A method of rendering a three dimensional (3D) image, comprising:
slicing the 3D image into a plurality of two dimensional (2D) slices;
generating one or more 2D bounding geometries for each of the 2D slices, each bounding geometry having nonempty texels representing portions of the 3D image;
rendering the 3D image by processing texels within each said bounding geometry.

2. The method according to claim 1, wherein the bounding geometry is a rectangle.

3. The method according to claim 1, whrein said rendering step includes:
generating a loop formed from contouring edges approximating boundaries of each connected regions of nonempty texels representing portions of the image within each said bounding geometry; and
rendering the 3D image by processing texels within each said loop.

4. The method according to claim 1, wherein said step of generating one or more bounding geometries includes grouping adjacent slices into a compressed slice.

5. The method according to claim 4, wherein compressed slice is by use of a logical OR operation.

6. The method according to claim 4, further including a step of transforming the compressed slice into a lower resolution form.

7. The method according to claim 6, wherein said step of transforming includes merging each k×k square region into a single voxel, where k is a natural number.

8. The method according to claim 7, wherein said merging is by low pass filtering.

9. The method according to claim 1, wherein said bounding geometry includes a bitmap mask that describes pixel-wise the nonempty texels enclosed therein.

10. The method according to claim 3, wherein said step of generating a loop includes:
identifying an edge between each adjacent empty and nonempty voxel pairs within each bounding geometry;
adding each said edge to an edge list;
connecting edges in the edge list according to direction and contour of the boundary of connected nonempty voxels until the loop is formed.

11. The method according to claim 10, wherein said nonempty voxel pairs is defined as 4-neighbor connected and said empty voxel pairs is defined as 8-neighbor connected.

12. The method according to claim 1, further including a simplication step by merging empty voxels into a non-empty voxel region before rendering.

13. The method according to claim 12, wherein said merging includes at least one of vertex removal and vertex merging.

14. The method according to claim 3, further including the step of removing self-intersecting contours within a loop.

15. The method according to claim 3, further including the step of space skipping processing to remove empty voxel regions within the loop prior to rendering.

16. A method of rendering a three dimensional (3D) image, comprising:
generating one or more 3D bounding geometries for the 3D image, each bounding geometry having nonempty texels representing portions of the 3D image; and
rendering the 3D image by processing texels within each said bounding geometry.

17. The method according to claim 16, wherein the bounding geometry is a cuboid.

18. The method according to claim 16, wherein said rendering step includes:
generating a loop formed from polygonal surfaces approximating boundaries of each connected regions of nonempty texels representing portions of the image within each said cuboid; and
rendering the 3D image by processing texels within each said loop.

19. A system for rendering a three dimensional (3D) image, comprising:
a bounding rectangle generator for generating one or more bounding geometries, each bounding geometry for bounding regions having nonempty texels representing portions of the 3D image;
a loop generator for generating a loop formed from contouring edges approximating boundaries of each connected regions of nonempty texels representing portions of the image within each said bounding geometry; and
a rendering processor for rendering the 3D image by processing texels within each said bounding geometry.

20. The system according to claim 19, further including:
a loop generator for generating a loop formed from contouring edges approximating boundaries of each connected regions of nonempty texels representing portions of the image within each said bounding geometry.

21. The system according to claim 19, wherein said bounding geometries include one of rectangles and cuboids.

22. A program storage device for storing codes executable by a computer to perform a method of rendering a three dimensional (3D) image, the method comprising:
generating one or more bounding geometries, each for bounding regions having nonempty texels representing portions of the 3D image; and
rendering the 3D image by processing texels within each said bounding geometry.
